(19) United States
(12) Patent Application Publication
(10) Pub. No.: US 2022/0318340 A1
(43) Pub. Date: Oct. 6, 2022

(54) PREDICTIVE METHODS FOR DETERMINING A VALUE OF A VARIABLE QUANTITY

(71) Applicant: Robert Bosch GmbH, Stuttgart (DE)

(72) Inventors: Tobias Krug, Munich (DE); Mouham Tanimou, Goeppingen (DE); Udo Schulz, Vaihingen/Enz (DE)

(21) Appl. No.: 17/700,855

(22) Filed: Mar. 22, 2022

(30) Foreign Application Priority Data
Apr. 1, 2021 (DE) 10 2021 203 321.0

(51) Int. Cl. G06F 17/18

(52) U.S. Cl. CPC G06F 17/18

(57) ABSTRACT

A method for determining a value of a variable quantity. A processing unit temporally consecutively receives multiple values of the variable quantity including respective associated detection points in time. Based on at least one of the multiple values and the respective associated detection points in time, the processing unit determines pieces of calculation information, which characterize a calculation rule used for determining a value of the variable quantity at a desired point in time. The pieces of calculation information are transferred from the processing unit together with at least one of the detection points in time to another processing unit, so that the calculation rule is determined there based on the received pieces of calculation information and the received detection points in time, and thus a value of the variable quantity may be determined at a desired point in time.

### FIELD

The present invention relates to multiple methods for determining a value of a variable quantity as well as to a processing unit and to a computer program for carrying out the methods.

### BACKGROUND INFORMATION

In various areas, variable quantities are measured, and the measured values are then transferred to somewhere else to be further processed there. In a vehicle, e.g., temperatures, velocities or positions are measured (as variable quantities) with the aid of sensors and an associated processing unit (control unit), which converts the sensor signals into measured values. The measured values are then transferred to another processing unit. There, the drive is then activated, e.g., based on the instantaneous velocity. Often times, measured values are also used within the scope of a control. One problem that occurs in the process is a time delay during the transfer or also detection and calculation of the measured values. This means that the input value (for example, measured value) used in the functional signal chain or event chain (for example, detection, processing, actuation using transfers, etc.) is outdated at the particular point of use in this chain, and a more up-to-date input value (for example, measured value) has since become available. In this connection, this is also referred to as latency.

### SUMMARY

According to the present invention, methods for determining a value of a variable quantity as well as a processing unit and a computer program for carrying out the methods, are provided. Advantageous embodiments of the present invention are disclosed herein.

The present invention relates to the transfer of measured values of variable quantities via, e.g., a communication medium. As mentioned, generally certain time delays arise in the process. A delay in the communication generally takes place as a time interval by which an event is delayed, as well as the time between the occurrence of an event and the occurrence of an expected subsequent event. Delay may arise in a variety of ways.

In the conventional manner, it may now be attempted, e.g., to compensate for a latency by extrapolation, to the extent that this latency cannot be (sufficiently) handled within the scope of the aforementioned options. The latency may be interpreted as dead time in the process by which, e.g., the position signals are compensated for. The goal in the process is to provide, not as is customary, the (sensor) value, i.e., the measured value, at the scanning or measuring point in time (e.g., t₀) to the user software, but to take into account the latency interpreted as dead time—the user software only receives the value at a later point in time (e.g., t₀+dT—in such a way that the (sensor) driver (i.e., the unit or processing unit initially processing the measured value) carries out an extrapolation at the point in time t₀ to the expected (sensor) value or measured value at the point in time t₀+dT. As a result of this approach, the (sensor) driver at times publishes at point in time t₀ the extrapolated value or measured value for the later point in time t₀+dT, which is then ideally processed by the user software at point in time t₀+dT.

The main problem with this procedure is the difficulty to be able to handle dynamic latencies (see, e.g., jitter); the exact latency namely would always have to be known in advance.

Moreover, with such a procedure, in the case of multiple user software components having just as many different latencies, a (sensor) driver would have to calculate just as many extrapolated values. Moreover, the driver component must have knowledge of the corresponding latencies, which is accompanied by a very close coupling of the driver and the user software.

Against this background, a procedure is now provided within the scope of the present invention which cancels this coupling, and considerably simplifies the handling of dynamic latencies.

In accordance with an example embodiment of the present invention, in the process, multiple values of the variable quantity are temporally consecutively received by a first processing unit, including respective associated detection points in time, e.g., as signal or measured values from a sensor. This may also take place (quasi) continuously or at certain intervals. Based on at least a portion of the multiple values and the respective associated detection points in time, the first processing unit then determines pieces of calculation information, which characterize a calculation rule used for determining a value of the variable quantity at a desired, in particular, later, point in time. This may, in particular, take place by way of a regression. The calculation rule itself does not necessarily have to be determined in the first processing unit in the process; rather, it is sufficient to determine the pieces of calculation information using, e.g., the type and/or parameter of the regression.

The pieces of calculation information are then transferred from the first processing unit, together with at least one of the detection points in time, to a second processing unit. Based on the received pieces of calculation information and the at least one received detection point in time, the calculation rule is then determined by the second processing unit. With this, a value of the variable quantity is then determined or calculated at a desired point in time. In this respect, it is sufficient when only pieces of information are transferred to the second processing unit which allow the calculation rule to be determined there.

Using the described procedure of the present invention, thus not only the specific value or signal value or measured value is transferred. Instead, a time stamp (i.e., the detection points in time for the detected sensor signals or at least one of these) as well as pieces of information (parameters, coefficients etc. for, e.g., the regression) are transferred, with the aid of which, on the receiver side (i.e., by the second processing unit), a function (the calculation rule) may be represented, which allows the signal value to be calculated in a scanning point in a time-compensated manner. In particular, a shared time basis is advantageous for this purpose. The close coupling of the driver (for, e.g., the sensor in the first processing unit) and user software components (on the second processing unit) for compensating for latencies is eliminated here in that the compensation is not calculated in the driver component in advance, but the use function calculates the required value (real value) of the sensor signal or, generally speaking, of the variable quantity, e.g., at the point in time of its processing. However, it is also possible to calculate the value at an even later point in time, if necessary or desired.

In accordance with an example embodiment of the present invention, the method is, in particular, based on the formation and use of a regression (online identification) of arbitrary signal profiles (of, e.g., temperature or position sensors) with the aid of, in particular, different approaches; e.g., a linear regression, curve or spline fitting, or also self-learning algorithms are possible. The purpose is to replace present interfaces, which are based on the transfer of scalar values, with the transfer of, e.g., regression type and regression coefficients (or the aforementioned pieces of calculation information). In this connection, it shall also be mentioned that the first and second processing units may, e.g., be two different control units (the first, e.g., including a driver for a sensor, the second including a controller); however, it may also be two parts or components of an individual control unit, which are communicatively coupled internally. Latencies also occur there, e.g., already during the detection or processing of the sensor signals in the driver.

The advantages include, e.g., the compensation of signal propagation times between functions (hardware or software functions), domains and control units, as well as the compensation of different measuring and execution rates (e.g., in the case of a sensor having a scan rate of 1 Hz, but a control loop having a 10 Hz processing interval; with the aid of the provided method, it could even be possible to calculate intermediate values, and thus it would be possible to “scan” or observe more frequently than 1 Hz).

For this purpose, it is possible to use regression methods and parameters which are optimal in an application-specific manner, which may possibly be supplemented with further means of signal conditioning (e.g., filtering in the frequency space using FIR/IIR) or be enriched with further data sources (e.g., map data, steering angle for optimizing the regression of the position signal).

Moreover, such a predictive latency correction allows control functions on machines or other devices to be made more precise. In this way, it becomes possible, e.g., to compensate for the message propagation time within different contexts (within a processing unit: intra-OS, inter-OS; within a combination of processing units: locally via bus, regionally/globally with the aid of edge and/or cloud computing techniques). This may also be utilized, e.g., for the odometric position correction of GNSS signals.

Furthermore, in accordance with an example embodiment of the present invention, it is possible in this way to utilize different calculation rules or different regressions for different receivers (i.e., two different second processing units or one second processing unit including different applications). As a result, there are also different pieces of calculation information which are to be determined and to be transferred. Moreover, when using a regression, which is typically present in or up to a certain order, it is possible for different receivers or applications to use different orders of the regression.

A processing unit according to the present invention, e.g., a control unit of a motor vehicle, is configured, in particular from a programming point of view, to carry out a method according to the present invention, in particular, the respective steps carried out by the first or by the second processing unit.

In addition, the implementation of a method according to the present invention in the form of a computer program or a computer program product having program code for carrying out all method steps is advantageous since this incurs particularly low costs, in particular when an executing control unit is also used for additional tasks and is therefore present anyhow. Suitable data media for providing the computer program are, in particular, magnetic, optical and electrical memories, such as hard disks, flash memories, EEPROMs, DVDs, and the like. It is also possible to download a program via computer networks (Internet, Intranet, and the like).

Further advantages and embodiments of the present invention are derived from the description and the figures.

The present invention is schematically shown based on exemplary embodiments in the figures and is described hereafter with reference to the figures.

### BRIEF DESCRIPTION OF THE DRAWINGS

FIG. 1 schematically shows a system for explaining the background of the present invention.

FIG. 2 schematically shows a system for explaining a sequence of a method according to the present invention in a preferred specific example embodiment of the present invention/FIG. 3 schematically shows a system for explaining a sequence of a method according to the present invention in a further preferred specific example embodiment of the present invention.

FIGS. 4A-4E schematically show different temporal sequences for explaining the present invention.

### DETAILED DESCRIPTION OF EXAMPLE EMBODIMENTS

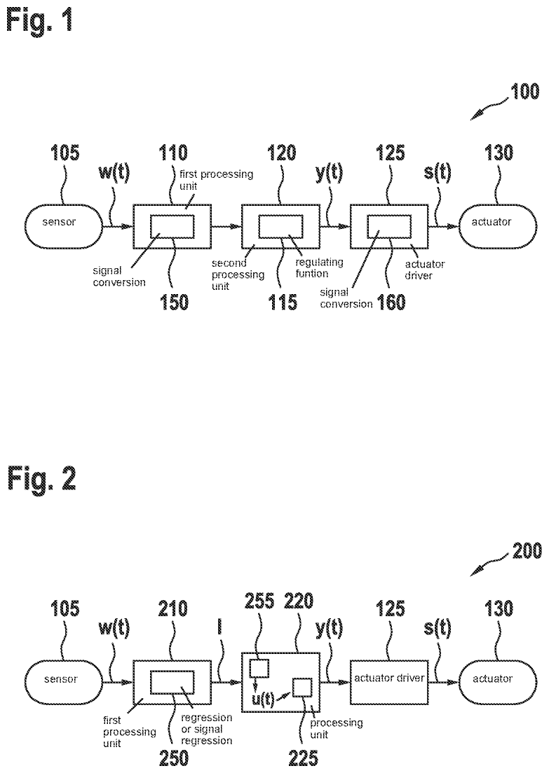

FIG. 1 schematically shows a system 100 based on which initially a procedure which is not according to the present invention for determining a value, e.g., a signal value or measured value of a variable quantity, is to be explained.

With the aid of a sensor 105, a signal value or measured value w(t) is (typically repeatedly) detected, which is supplied to a first processing unit 110, here a so-called sensor driver. Such a sensor driver is comparable to a device driver, i.e., it may, e.g., be a software module which controls the interaction with the connected, installed hardware or the hardware module (for example the ADC of the microcontroller of the control unit). In addition, the driver, on the one hand, communicates directly with the hardware, e.g., via the communication bus or the hardware interface and exchanges control signals and data with the hardware (for example, the configuration, operation, control, diagnosis, etc.; reading out of digital raw values of the ADC). On the other hand, the driver of the application software offers a standardized interface so that hardware of different manufacturers (i.e., both different sensors, sensor interfaces, and other ADC or microcontroller types) may be used in the same manner. By virtue of their function, sensor drivers are highly hardware-dependent and operating system-dependent. Here too, the driver enables a standardized mode of communication with differing systems. The main task of device drivers, or sensor drivers here, is the provision of functions close to hardware by the hardware abstraction layer.

In this way, e.g., a temperature may be measured with the aid of NTC or PTC thermistors or thermoelectrically or ferromagnetically or in an infrared-based manner or with the aid of other sensor principles, for example an analog voltage value. The associated hardware of the signal processing is different for this purpose. The respective associated sensor driver (software) operates the hardware and generates a software message (digital value) including a quantified physical temperature value (e.g., motor temperature Tₘₒₜ=90° C., wherein the data type, e.g., “signed integer” and the quantization, e.g., 1 bit=1° C. are established). The same then also applies to drivers for actuators, etc.

There, i.e., in the sensor driver, a signal conversion 150 takes place (an analog voltage value is, e.g., converted into a digital value), and the value is then, e.g., provided to a regulating function 115 which is executed, e.g., on a second processing unit 120, in which the value is processed, e.g., to determine a control value for an actuator 130. As was already mentioned at the outset, an extrapolation of the measured value may possibly take place even prior to the transfer to the second processing unit. For the control value, initially, e.g., a reference variable y(t) is provided to an actuator driver 125. There, a signal conversion 160 then takes place into control value s(t), which is then set at the actuator (a digital value is, e.g., converted into an analog voltage).

In the process, y(t) is a digital physical value of a control or regulating function. In contrast, s(t) is the value of the control signal which the driver calculates for the actuator and which is converted by the hardware module for activating the actuator.

For example, y(t) may be a certain injection amount for a cylinder of an engine (for example 10 mm³) at a certain start of injection (−10° crankshaft degrees before TDC). Both are digital signals or messages. The driver for the actuator translates these pieces of information into a voltage and current profile for the hardware output stages or power semiconductors for the respective injector. The driver for the actuator has knowledge of the relationships between the current and voltage, and the flow rate of the valve. Since there are both solenoid actuators and piezo actuators in injectors, the driver and the output stage concepts for activating the actuators therefor also differ. The driver for the actuator may also have a subordinate control loop, for example including position determination and regulation. Furthermore, drivers for sensors and actuators may also have diagnoses or error recognitions.

FIG. 2 schematically shows a system 200 in which a procedure according to the present invention for determining a value, e.g., a signal value or measured value of a variable quantity, is to be explained based on one preferred specific embodiment. A basic idea of the present invention is to aggregate the surroundings signals in a system and to continuously identify, e.g., the regressions of these signals therefrom online (i.e., in a processing unit, and in particular at the execution time). For this purpose, a control loop or standard control loop, as shown in FIG. 1, is to be considered (it may also be an operative combination of different functions which are distributed among different processing units).

Based on this standard control loop, a regression or signal regression 250 is carried out, instead of the traditional signal conversion, in first processing unit 210. Following the signal detection, a signal undergoes a processing at the component driver or first processing unit 210, as well as a potential filtering, until it, possibly after appropriate calculation, is finally present at a function 225 (this may, again, be a regulating function). The goal of the regression is that the correct value of the signal may be calculated directly by the use function based on a regression rule.

The sensor component driver or first processing unit 210 receives the values or sensor signals w(t) from sensor 105. From this, pieces of calculation information I are then determined with the aid of a regression 250, which characterize a calculation rule 255, from which a value u(t) (may also be referred to as a reference variable here) of the variable quantity is determinable at a desired point in time. Compared to the procedure according to FIG. 1, it is not an actual value of the variable quantity or of the signal which is transferred, but a piece of calculation information. The following relationship results in the process:

u(t)=fu(t,t−Δt, . . . ,t−nΔt,w(t),w(t−Δt), . . . ,w(t−nΔt))

where n is the order of the regression. Value u(t) may be determined for a desired point in time, e.g., the processing point in time, in the second processing unit and may then then be used in the regulation or regulating function 225. Corresponding input/output relationships result for the remaining components in the calculation chain. For reference variable y(t), this would result as

y(t)=fy(t,t−Δt, . . . ,t−mΔt,u(t),u(t−Δt), . . . ,u(t−mΔt)).

Using regression order m, and for output variable s(t) (the final controlled variable for the actuator) results as

s(t)=fS(t,t−Δt, . . . ,t−kΔt,y(t),y(t−Δt), . . . ,y(t−kΔt))

using regression order k. The regressions here may, e.g., be represented as a linear function, such as e.g.,

f(t)=m*t

or as a non-linear function, such as e.g.,

f(t)=m*|sin(t)|

Neural networks, e.g., represent a special version of these regressions. The input parameters of the different regression functions may be both scalar and vectorial.

With this consideration, it may generally be assumed that the more the past is taken into consideration in the aggregation of the signal, the better is the signal quality. In the process, orders n, m and k are viewed as maximum orders of the corresponding functions, i.e., even though the same regression function is provided for one and the same sensor signal, not all orders are taken into consideration by consumers (e.g., regulating functions) in the user software; as a result, it is possible for a consumer (a certain use function) to presuppose the calculation using the maximum order, while another consumer may already be satisfied with a first or second order regression. The crucial factor in the process is the signal quality which is required by the consumer, this possibly referring to different criteria, e.g., stability, response behavior or accuracy.

Several examples shall be mentioned hereafter, in which the described procedure may be used. In the case of a vehicle or machine position determination (e.g., for calculating spray amounts to be delivered by a field sprayer), global navigation satellite system (GNSS) sensors are employed, which generally operate at a scan rate of, e.g., 1 Hz. The position sensor system may be improved through use of this method, so that position signals may be determined using essentially higher scan rates and/or position values between actual GNSS scan steps.

An extrapolation (also “upsampling”), i.e., an (anticipatory) determination of sensor signals may be used, e.g., when using a temperature sensor system at a lower scan rate.

Or in vehicles, e.g., a sensor system having a limited angular resolution is situated at the crankshaft. This low resolution usually results from the measuring method used, which only allows an increase in the angular resolution at high costs. Here, the described method could be utilized for a considerable increase in the resolution of the crankshaft angle.

During the calculation of quantities using state observers (e.g., expansion of Kalman filters), filter functions may be used via regressions, instead of via scalar values.

In the case of an adaptive update algorithm which takes changes to the input signal into consideration, the described procedure may, e.g., be used to reduce the transfer rate of the regression coefficients.

It must be taken into consideration in the process that different regulating functions may have different requirements (regression method, regression order) with regard to the regression at the sensor. When a new feature comes with a further requirement (regression order, regression method), this may automatically and dynamically be configured at the sensor component driver.

FIG. 3, by way of example, shows the situation from FIG. 2, however additionally a further piece of calculation information I′ for another calculation rule 255′ having, e.g., also another regulating function 225′ is determined on a further second processing unit 220′ and is transferred there by first processing unit 210. Accordingly, another actuator 130′ is activated using another driver 125′.

This mechanism may be easily comprehended based on linear functions. For this purpose, the determination of positions pos0, pos1, pos2 at points in time t0, t1, t2 shall be considered for a system made up of a machine which is moving in the space:

t0→pos0=(x0,y0,zσ),t1→pos1=(x1,y1,z1),t2→pos2=(x2,y2,z2);

The signal detection shall be illustrated in a drastically simplified manner by time detection w(t)=t, i.e., the detection or measuring point in time shall be identical to the respective measured value. The component drivers then, e.g., provide a linear function having the gradient 1, i.e., u(t)=w(t)=t. The individual position elements are now calculated from the regulating function, using a regression function according to the manner of a linear equation system of the form

ƒₚₒₛ(t)=(βₓ(t),ƒ_{y}(t),ƒ_{z}(t)) where

βₓ(t)=υₓ*t/[s];ƒ_{y}(t)=υ_{y}*t/[s];ƒ_{z}(t)=υ_{z}*t/[s]

At a certain point in time t=5 at which the regulating function would be calculated, the following would then result, where υₓ=1, υ_{y}=2 and υ_{z}=4 (velocities):

ƒ(t=5)=(5υₓ,5υ_{y},5υ_{z})=(5,10,20) where υₓ=1,υ_{y}=2,υ_{z}=4.

This function would naturally take on another function value if the scan or detection point in time (e.g., t_{erf}=3) had been used as a basis, which demonstrates the reason behind the regression function. In this example, the standardized time at a virtual zero point shall be noted. Relationship t=5 expresses that a time period of 5 s (standardization to second) since the detection of the sensor value (virtual zero point) has elapsed.

In a real technical system, this could be implemented, for example, by a global time synchronization and the transfer of the time stamp of the detection of the sensor value. The following consideration would then result using the sample of a UNIX time stamp in seconds for 01/01/2000 at 00:00:00

t=t_{actual}/[s]−t_{erf}/[s]=946.681.205-946.681.200=5;

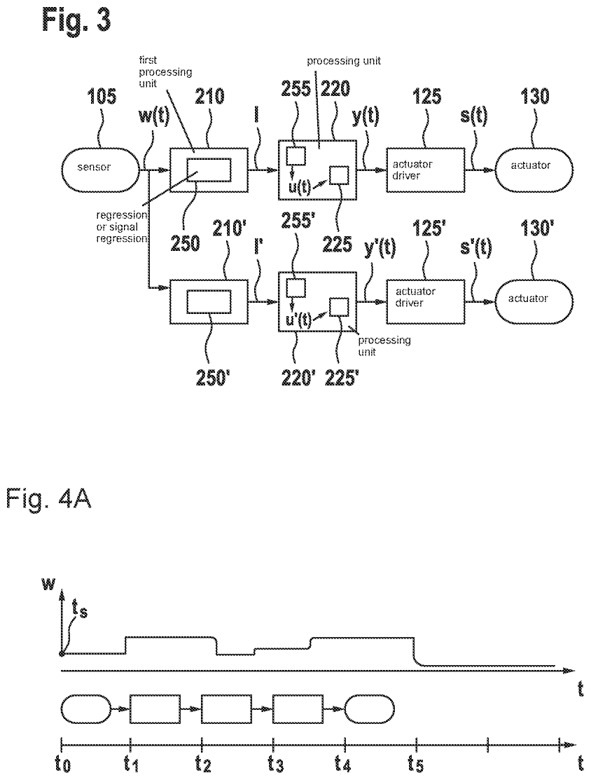

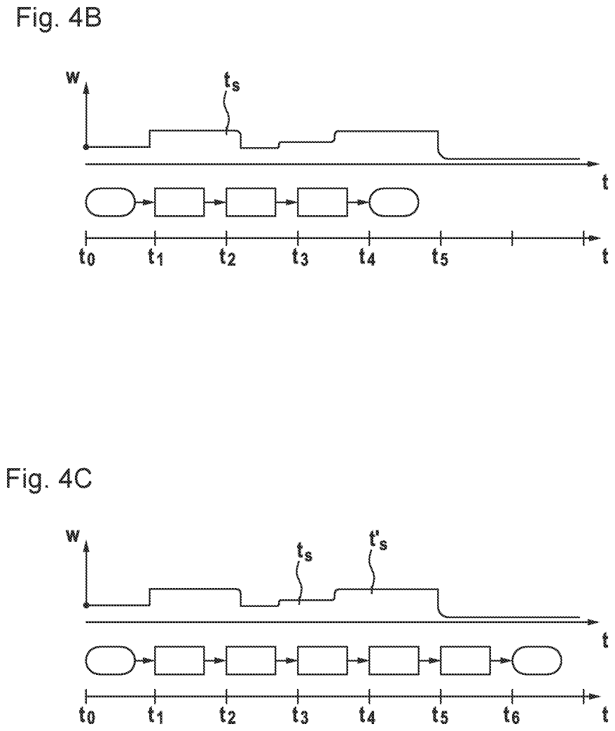

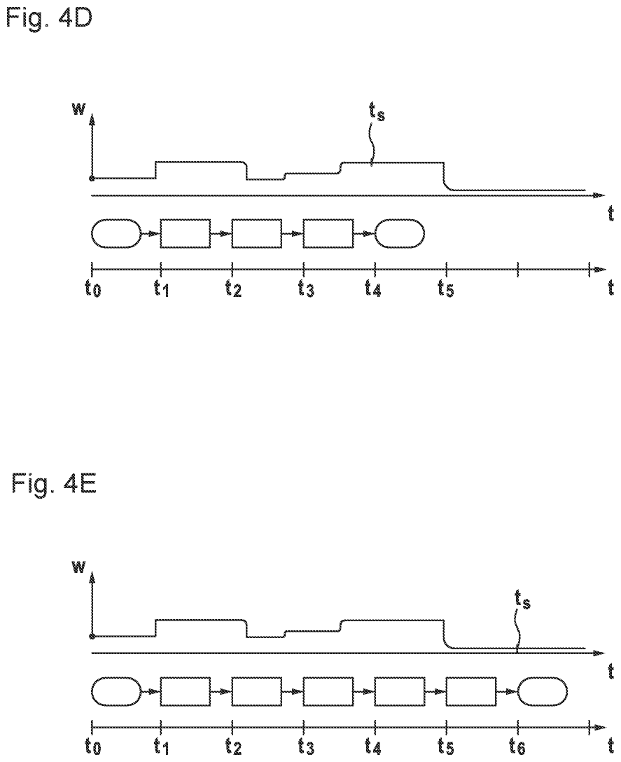

FIGS. 4A-4E show a respective profile of a value w (sensor or measured value) over time t for multiple examples, as well as different processes at different points in time t₀ to t₆. tₛ denotes the respective point in time at which the measured value which is ultimately used applies.

In the example of FIG. 4A, the measured value is detected at point in time t₀, processed in the conventional manner at point in time t₁, e.g., by signal conversion (see FIG. 1), at point in time t₂ this measured value is used in the regulating function to determine a control value for the actuator, at point in time t₃ the control value is sent to the actuator, and at point in time t₄ the actuator assumes the control value.

The measuring point at point in time tₛ=t₀ is thus used here, so that an input delay of t₂−t₀ arises with the regulating function and an output delay of t₄−t₂ arises until the actual actuation at the actuator.

In the example of FIG. 4B, it is now not the measured value, but the piece of calculation information which is transferred, so that the measured value is only determined for the use in the regulating function at point in time t₂, i.e., tₛ=t₂. The input delay thus does not carry any weight here, i.e., it does not result in an outdated measured value.

In the example of FIG. 4C, initially a filter is employed at point in time t₂, and only then is the piece of calculation information transferred, so that the measured value is only determined for the use in the regulating function at point in time t₃, i.e., tₛ=t₃. The input delay, t₃−t₀ here, also does not carry any weight here. Additionally, a point in time t′ₛ=t₄ is shown here, at which a measured value is determined for, e.g., a monitoring function. Here, an input delay t₄−t₀ exists, which, however, does not carry any weight when the measured value is calculated again.

Compared to the example of FIG. 4B, the measured value in the example of FIG. 4D for the use in the actuator is only determined at point in time t₄, i.e., tₛ=t₄. Here, the input delay does not carry any weight, and the output delay of the driver also does not.

The example of FIG. 4E is similar to the example of FIG. 4C, however the measured value for, e.g., the regulating function and monitoring function, is determined in each case at point in time tₛ=t₇. Here, the input delay also does not carry any weight, and the output delay also does not.

1-12. (canceled)

13. A method for determining a value of a variable quantity, the method comprising the following steps:
temporally consecutively receiving, by a processing unit, multiple values of the variable quantity including respective associated detection points in time;
determining, by the processing unit based on at least one of the multiple values and the respective associated detection points in time, pieces of calculation information which characterize a calculation rule used for determining a value of the variable quantity at a desired point in time; and
transferring the pieces of calculation information from the processing unit together with at least one of the detection points in time to another processing unit, so that the calculation rule is determined by the other processing unit based on the received pieces of calculation information and the at least one received detection point in time so that a value of the variable quantity may be determined at a desired point in time.

14. The method as recited in claim 13, wherein the pieces of information are determined by the processing unit based on a regression.

15. The method as recited in claim 14, wherein the pieces of calculation information encompass a type and/or parameter of the regression.

16. The method as recited in claim 14, wherein the pieces of calculation information are determined by the processing unit based on a filtering applied after the regression.

17. The method as recited in claim 13, wherein the multiple values of the variable quantity are received as signal values or measured values of a sensor.

18. The method as recited in claim 13, wherein the calculation rule is determined by the at least one other processing unit based on the received pieces of calculation information and the at least one received detection point in time so that a value of the variable quantity may be determined at a desired point in time.

19. A method for determining a value of a variable quantity, the method comprising the following steps:
receiving pieces of calculation information by a processing unit from another processing unit together with at least one detection point in time, the pieces of calculation information having been determined by the other processing unit based on multiple values and the respective associated detection points in time of the variable quantity;
determining a calculation rule by the processing unit based on the received pieces of calculation information and the at least one received detection point in time; and
determining, by the processing unit using the calculation rule, a value of the variable quantity at a desired point in time.

20. The method as recited in claim 19, wherein the value of the variable quantity determined by the processing unit is used for a regulation.

21. The method as recited in claim 19, wherein a processing point in time of the processing unit or a later usage point in time is used as the desired point in time for which the value is determined by the processing unit.

22. A processing unit configured to determine a value of a variable quantity, the processing unit configured to:
temporally consecutively receive, by the processing unit, multiple values of the variable quantity including respective associated detection points in time;
determine, by the processing unit based on at least one of the multiple values and the respective associated detection points in time, pieces of calculation information which characterize a calculation rule used for determining a value of the variable quantity at a desired point in time; and
transfer the pieces of calculation information from the processing unit together with at least one of the detection points in time to another processing unit, so that the calculation rule is determined by the other processing unit based on the received pieces of calculation information and the at least one received detection point in time so that a value of the variable quantity may be determined at a desired point in time.

23. A processing unit configured to determine a value of a variable quantity, the processing unit configured to:
receive pieces of calculation information by the processing unit from another processing unit together with at least one detection point in time, the pieces of calculation information having been determined by the other processing unit based on multiple values and the respective associated detection points in time of the variable quantity;
determine a calculation rule by the processing unit based on the received pieces of calculation information and the at least one received detection point in time; and
determine, by the processing unit using the calculation rule, a value of the variable quantity at a desired point in time.

24. A non-transitory machine-readable memory medium on which is stored a computer program for determining a value of a variable quantity, the computer program, when executed by a processing unit, causing the processing unit to perform the following steps:
temporally consecutively receiving, by a processing unit, multiple values of the variable quantity including respective associated detection points in time;
determining, by the processing unit based on at least one of the multiple values and the respective associated detection points in time, pieces of calculation information which characterize a calculation rule used for determining a value of the variable quantity at a desired point in time; and
transferring the pieces of calculation information from the processing unit together with at least one of the detection points in time to another processing unit, so that the calculation rule is determined by the other processing unit based on the received pieces of calculation information and the at least one received detection point in time so that a value of the variable quantity may be determined at a desired point in time.
